(19) United States
(12) Patent Application Publication
(10) Pub. No.: US 2024/0152672 A1
(43) Pub. Date: May 9, 2024

(54) METHOD AND SYSTEM FOR PREDICTING WATER FLOODING RECOVERY OF FAULT BLOCK RESERVOIRS CONSIDERING WHOLE PROCESS OPTIMIZATION

(71) Applicants: China University of Petroleum (East China), Qingdao (CN); Shandong University of Science And Technology, Qingdao (CN)

(72) Inventors: Jian Hou, Qingdao (CN); Kang Zhou, Qingdao (CN); Shuai Liu, Qingdao (CN); Zhibin An, Qingdao (CN); Qingjun Du, Qingdao (CN); Bei Wei, Qingdao (CN); Yongge Liu, Qingdao (CN)

(21) Appl. No.: 18/067,793

(22) Filed: Dec. 19, 2022

(30) Foreign Application Priority Data
Nov. 7, 2022 (CN) 202211384610.7

(51) Int. Cl. G06F 30/28

(52) U.S. Cl. CPC G06F 30/28

(57) ABSTRACT

A method and system for predicting water flooding recovery of fault block reservoirs considering a whole process optimization includes: determining influencing factors in water flooding recovery of fault block reservoirs; screening master parameters of the water flooding recovery of the fault block reservoirs; determining a single-factor correlation between the water flooding recovery of the fault block reservoirs and the master parameters; designing multi-factor orthogonal experimental schemes; performing a whole-process water flooding optimization for each of the experimental schemes including separate-layer injection and production, well-type conversion, and injection and production adjustment, to obtain the maximum water flooding recovery; and determining a prediction model of the water flooding recovery of the fault block reservoirs using least square method based on results of the whole process optimization of orthogonal experiments, further obtaining a prediction model of the water flooding recovery of the fault block reservoirs.

### CROSS REFERENCES

This application claims priority to Chinese Patent Application Ser. No. CN202211384610.7 filed on 7 Nov. 2022.

### FIELD OF THE INVENTION

The present invention relates to the technical field of oil and gas field development, and in particular, to a method and system for predicting water flooding recovery of fault block reservoirs considering a whole process optimization.

### BACKGROUND OF THE INVENTION

Fault block reservoirs are widely developed in China, among which the proven ones have huge geological reserves and great development value. However, fault block reservoirs, characterized by unique geological structures, high fault development, complex oil-water system, and strong reservoir heterogeneity, are difficult to explore and develop. At present, crude oil is widely exploited by water flooding development at home and abroad. A number of development dements of water flooding fault block reservoirs have entered into high water cut stage, the water flooding effects of which vary greatly, with some up to 60% or more and individual ones less than 10%. Therefore, it is a key for optimal planning and adjustment of fields to accurately predict water flooding recovery in different development dements. At present, water flooding recovery prediction is mainly performed by core analysis, water flooding characteristic curve, production decline, and empirical formula. Core analysis is based on core model flooding experiments, and fails to accurately simulate fault characteristics due to the size limitation of core models. Water flooding characteristic curve and production decline are based on the analysis of water flooding development effect of integral reservoirs, without considering the influence of specific parameters of fault block reservoirs, such as fault block area, fault density, and water body multiples. Empirical formula, depending on specific reservoir types, is limited in generalization. Therefore, it is urgent to provide a method for predicting water flooding recovery of fault block reservoirs because that the existing recovery prediction methods fail to accurately grasp the potential space of water flooding development of the fault block reservoirs.

### SUMMARY OF THE INVENTION

In view of the deficiencies of the prior art and the development characteristics of fault block reservoirs, the present invention proposes a method for predicting water flooding recovery of fault block reservoirs considering a whole process optimization. Water flooding recovery of fault block reservoirs can be predicted more accurately in the present invention, which is of great significance for evaluating and understanding the development potential of old oilfields such as water flooding fault block reservoirs and making reasonable development and optimization schemes, effectively assisting optimal planning and deployment of fields.

The present invention further provides a system for predicting water flooding recovery of fault block reservoirs considering a whole process optimization.

### EXPLANATION OF TERMS

1. Water flooding recovery refers to the ratio of cumulative oil production in geological reserves at the end of oilfield development by water flooding.
2. Comprehensive water cut of reservoirs refers to the ratio of water in the total produced liquid quantity of all producing wells calculated with a reservoir or production unit as a whole, representing the overall water cut of the reservoirs.

Technical solutions of the present invention are:

A method for predicting water flooding recovery of fault block reservoirs considering a whole process optimization includes the following steps:
(1) determining influencing factors in water flooding recovery of fault block reservoirs
collecting geological information of fault block reservoirs in a target block, determining reservoir static physical parameters and production dynamic parameters in combination with field production data, and determining fault block characteristic parameters affecting water flooding recovery of the fault block reservoirs based on basic characteristics and actual development thereof;
(2) screening master parameters of the water flooding recovery of the fault block reservoirs
changing values of each of the influencing factors using single-factor analysis method; calculating the water flooding recovery of the fault block reservoirs by using numerical simulators of water flooding; analyzing significance of the influencing factors with a variance D as an evaluating criterion for primary and secondary influencing factors, where the greater the variance D is, the higher the significance of the influencing factors is; and selecting the influencing factors with variances greater than 1 as master parameters of the water flooding recovery of the fault block reservoirs;
(3) determining a single-factor correlation between the water flooding recovery of the fault block reservoirs and the master parameters
determining a correlation between flooding recovery of the fault block reservoirs and each of the master parameters using non-linear regression method, where the correlation includes power function relationship, logarithmic function relationship, and polynomial function relationship;
(4) designing multi-factor orthogonal experimental schemes based on the master parameters
determining the number of levels and values of each of the master parameters in combination with allowable range of parameters in fault block reservoir field, and selecting an appropriate orthogonal experimental design table;
(5) performing a whole-process water flooding optimization for each of the orthogonal experimental schemes
with the maximum water flooding recovery as a target, optimizing separate-layer injection and production at the moment of production, optimizing well-type conversion when comprehensive water cut of the reservoirs reaches 90%, and optimizing injection and production adjustment when the comprehensive water cut of the reservoirs reaches 95%;
(6) establishing a prediction model for the water flooding recovery of the fault block reservoirs
determining a formula of a correlation model between the water flooding recovery of the fault block reservoirs and all the master parameters according to the single-factor correlation between water flooding recovery and the master parameters determined in step (3); determining unknown parameters of the formula of the correlation model between the water flooding recovery and all the master parameters using least square method based on results of the whole process optimization of orthogonal experiments, further obtaining a prediction model of the water flooding recovery of the fault block reservoirs; and
(7) calculating the water flooding recovery of the fault block reservoirs
calculating the water flooding recovery of the fault block reservoirs according to the prediction model of the water flooding recovery of the fault block reservoirs established in step (6).

Further preferably, in step (1), the selected reservoir static physical parameters include underground crude oil viscosity μₒ, effective formation thickness h, permeability k, inter-layer permeability ratio Vₘ, and variation coefficient of permeability Vᵣ; the selected production dynamic parameters include well spacing density W_{d} and production multiples PV; and the selected characteristic parameters of the fault block reservoirs include fault block area A, fault density d_{f}, and water body multiples N.

Further preferably, the variance D in step (2) is calculated by formula (I):

$$D = \frac{{\sum }_{i = 1}^{n} {( {X}_{i} - X )}^{2}}{n} \qquad ( I )$$

In formula (I), D represents the variance; n represents the number of samples; Xᵢ represents the water flooding recovery corresponding to the i value of a certain influencing factor, %; and X represents an average value of n water flooding recovery, %.

Further preferably, the power function relationship, logarithmic function relationship and polynomial function relationship in step (3) are shown in formula (II), formula (III) and formula (IV), respectively:

R=aX^{b} (II)

R=a ln(X)+b (III)

R=a₀+a₁X+a₂X²+a₃X³+ . . . +aₙXⁿ+ . . . (IV)

In formula (II), formula (III) and formula (IV), R represents the recovery, %; X represents the master parameters; and a, b, aₙ represents undetermined coefficient of the functional relationship with a subscript n=0, 1, 2, 3 . . . .

A specific implementation process of step (4) preferred according to the present invention includes:
firstly, determining the upper and lower limits of values of parameters required for orthogonal experiment analysis based on distribution intervals of the reservoir static physical parameters and fault block characteristic parameters determined in step (1) obtained from field tests;
secondly, determining the upper and lower limits of values of the required production dynamic parameters according to distribution intervals of the production dynamic parameters used in developed reservoirs of the same type; taking several levels for each of the parameters in the orthogonal experiment analysis; and uniformly sampling values of each of the levels between the upper and lower limits of the values of each of the parameters; and
finally, determining the orthogonal experimental design table and compiling the multi-factor orthogonal experimental schemes according to the determined number of the master parameters and several values of the levels of each of the parameters.

A specific implementation process of step (5) preferred according to the present invention includes:
dividing multi-layer reservoirs into two sets of layer series of development longitudinally at the moment of water flooding into production according to the orthogonal experiment schemes for each of the fault block reservoirs; specifically, calculating different combinations of the multi-layer reservoirs by using numerical simulators of water flooding reservoirs, where the combination of the multi-layer reservoirs corresponding to the scheme with the maximum water flooding recovery is a preferred implementation of the separate-layer injection and production;
converting producing wells into water injection wells every other when the comprehensive water cut of the reservoirs reaches 90%, that is, converting the original line of producing wells into the producing wells and the water injection wells arranged at intervals; and
calculating injection rates of each of the water injection wells and liquid producing rates of each of the producing wells as adjustable variables by using the numerical simulators of water flooding reservoirs when the comprehensive water cut of the reservoirs reaches 95%, where the combination of the injection rates of each of the water injection wells and the liquid producing rates of each of the producing wells corresponding to the scheme with the maximum water flooding recovery is a preferred injection and production scheme.

Further preferably, the correlation model between the water flooding recovery of the fault block reservoirs and all the master parameters in step (6) is shown in formula (V):

R=a₁ ln(A)+a₂ log(PV)+a₃ ln(μₒ)+a₄(d_{f})+a₅k^{b}+a₆Vₘ^{c}+a₇Vᵣ²+a₈Vᵣ+a₉ (V)

In formula (V), R represents the recovery, %; A represents the fault block area, km²; PV represents the production multiples; μₒ represents the underground crude oil viscosity, mPa·s; d_{f} represents the fault density, bar/km²; k represents the permeability, 10⁻³ μm²; Vₘ represents the inter-layer permeability ratio; and Vᵣ represents the variation coefficient of permeability.

A system for predicting water flooding recovery of fault block reservoirs considering a whole process optimization includes:
an influencing factor determining module, configured to determine influencing factors in water flooding recovery of fault block reservoirs;
a master parameter screening module, configured to screen master parameters of the water flooding recovery of the fault block reservoirs;
a single-factor correlation determining module, configured to determine a single-factor correlation between the water flooding recovery of the fault block reservoirs and the master parameters;
a multi-factor orthogonal experimental scheme designing module, configured to design multi-factor orthogonal experimental schemes based on the master parameters;
a whole-process water flooding optimizing module, configured to perform a whole-process water flooding optimization for each of the experimental schemes;
a prediction model establishing module, configured to establish a prediction model for the water flooding recovery of the fault block reservoirs; and
a water flooding recovery calculating module, configured to calculate the water flooding recovery of the fault block reservoirs according to the established prediction model of the water flooding recovery of the fault block reservoirs.

Beneficial effects of the present invention are:
1. Fault block reservoir characteristics with significant impact can be accurately reflected in the recovery prediction model by determining the fault block characteristic parameters affecting water flooding recovery, effectively improving the pertinence of the prediction model.
2. Factors that have little influence on recovery can be excluded from the prediction model by screening the master parameters of the water flooding recovery of the fault block reservoirs, ensuring the prediction accuracy and improving the simplicity of the prediction model.
3. It can provide a basic model for the establishment of the model of multi-factor nonlinear regression by determining the single-factor correlation between the water flooding recovery and the master parameters, greatly improving the accuracy of the prediction model of the water flooding recovery.
4. The final recovery of the fields can be truly reflected under the current economic and technical level by establishing the recovery prediction model through the results of the whole process optimization by water flooding, providing guidance for optimal planning and deployment of the fields.

### BRIEF DESCRIPTION OF THE DRAWINGS

FIG. 1 is a schematic diagram of the implementation process of the method for predicting water flooding recovery of fault block reservoirs considering a whole process optimization according to the present invention;

FIG. 2 is a schematic diagram of the prediction model of the water flooding recovery of the fault block reservoirs; and

FIG. 3 is a schematic diagram of the verification results of the prediction model of the water flooding recovery of the fault block reservoirs.

### DETAILED DESCRIPTION OF THE EMBODIMENTS

The present invention will be further explained in details with reference to the accompanying drawings and specific embodiments, whereby the above and other objects, features and advantages of the present invention would be more obvious and understandable.

### Embodiment 1

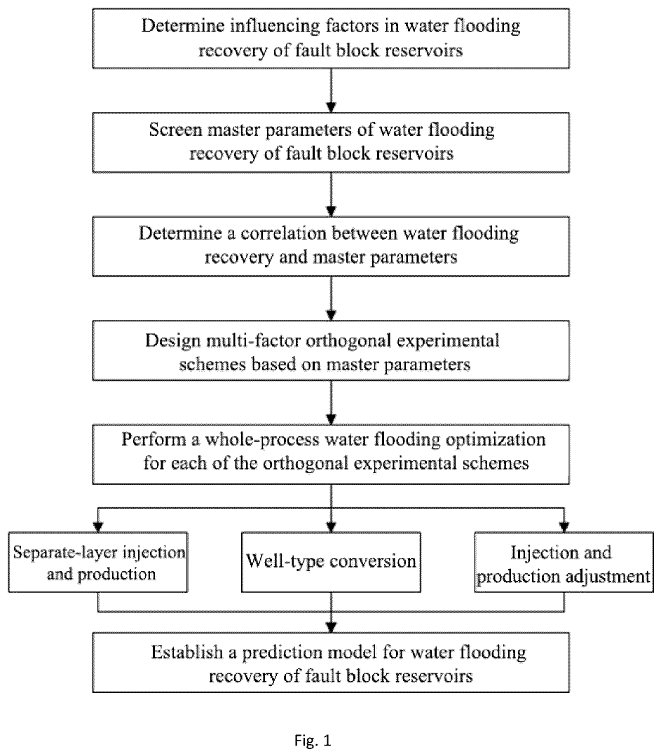

A method for predicting water flooding recovery of fault block reservoirs considering a whole process optimization, as shown in FIG. 1, includes the following steps:

(1) Determining Influencing Factors in Water Flooding Recovery of Fault Block Reservoirs

Geological information of fault block reservoirs was collected in a target block; reservoir static physical parameters and production dynamic parameters were determined in combination with field production data; and fault block characteristic parameters affecting water flooding recovery of the fault block reservoirs were determined based on basic characteristics and actual development thereof.

(2) Screening Master Parameters of Water Flooding Recovery of Fault Block Reservoirs

Values of each of the influencing factors were changed using single-factor analysis method; the water flooding recovery of the fault block reservoirs was calculated by using numerical simulators of water flooding; significance of the influencing factors was analyzed with a variance D as an evaluating criterion for primary and secondary influencing factors, where the greater the variance D was, the higher the significance of the influencing factors was; and the influencing factors with variances greater than 1 were selected as master parameters of the water flooding recovery of the fault block reservoirs.

(3) Determining a Single-Factor Correlation Between the Water Flooding Recovery of the Fault Block Reservoirs and the Master Parameters

A correlation between flooding recovery of the fault block reservoirs and each of the master parameters was determined using non-linear regression method, where the correlation included power function relationship, logarithmic function relationship, and polynomial function relationship.

(4) Designing Multi-Factor Orthogonal Experimental Schemes Based on the Master Parameters

The number of levels and values of each of the master parameters were determined in combination with allowable range of parameters in fault block reservoir field, and an appropriate orthogonal experimental design table was selected.

(5) Performing a Whole-Process Water Flooding Optimization for Each of the Orthogonal Experimental Schemes

With the maximum water flooding recovery as a target, separate-layer injection and production was optimized at the moment of production; well-type conversion was optimized when comprehensive water cut of the reservoirs reaches 90%; and injection and production adjustment was optimized when the comprehensive water cut of the reservoirs reaches 95%.

(6) Establishing a Prediction Model for the Water Flooding Recovery of the Fault Block Reservoirs

A formula of a correlation model between the water flooding recovery of the fault block reservoirs and all the master parameters was determined according to the single-factor correlation between water flooding recovery and the master parameters determined in step (3); unknown parameters of the formula of the correlation model between the water flooding recovery and all the master parameters were determined using least square method based on results of the whole process optimization of orthogonal experiments, so as to obtain a prediction model of the water flooding recovery of the fault block reservoirs.

(7) Calculating the Water Flooding Recovery of the Fault Block Reservoirs

The water flooding recovery of the fault block reservoirs was calculated according to the prediction model of the water flooding recovery of the fault block reservoirs established in step (6).

### Embodiment 2

The method for predicting water flooding recovery of fault block reservoirs considering a whole process optimization according to Embodiment 1, the differences are:

In step (1), geological information of M fault block reservoirs, a target block, was collected; reservoir static physical parameters and production dynamic parameters were determined in combination with field production data; and fault block characteristic parameters affecting water flooding recovery of the fault block reservoirs were determined based on basic characteristics and actual development thereof.

M fault block belongs to a fan-open fault block reservoir with a dip angle among 2 to 5°, the updip direction of which is blocked by two intersecting faults and open to one side. The plane shape is like a fan. Based on the field data and the characteristics of block development, the selected reservoir static physical parameters include underground crude oil viscosity μₒ, effective formation thickness h, permeability k, inter-layer permeability ratio Vₘ, and variation coefficient of permeability Vᵣ; the selected production dynamic parameters include well spacing density W_{d} and production multiples PV; and the selected characteristic parameters of the fault block reservoirs include fault block area A, fault density d_{f}, and water body multiples N.

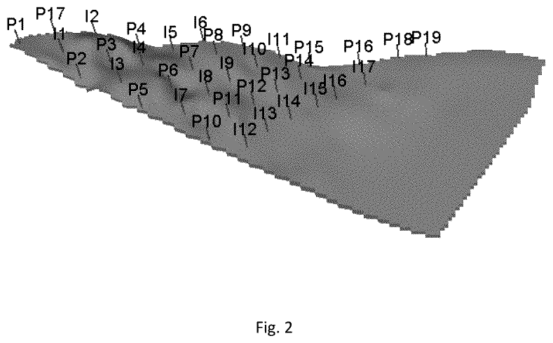

A model of reservoir numerical simulation is established according to the actual data of M fault block field, which is divided into 62×145×5=44950 grids using corner grid system. The wells are arranged parallel to the oil-water boundary line according to the characteristics of fault blocks and considering the actual situation in the field, with a well pattern of determinant. The model of reservoir numerical simulation is shown in FIG. 2.

The variance D in step (2) is calculated by formula (I):

$$D = \frac{{\sum }_{i = 1}^{n} {( {X}_{i} - X )}^{2}}{n} \qquad ( I )$$

In formula (I), D represents the variance; n represents the number of samples; Xᵢ represents the water flooding recovery corresponding to the i value of a certain influencing factor, %; and X represents an average value of n water flooding recovery, %.

The influencing factors in water flooding recovery of fault block reservoirs and calculation results of primary and secondary factors thereof are shown in Table 1:

TABLE 1

| | | | | | | Inter- | Variation | | | |
|---|---|---|---|---|---|---|---|---|---|---|
| | | | Under | | | layer | coefficient | | | |
| | Well | | ground | Effective | | perme- | of | | Water | Fault |
| | spacing | Production | crude oil | formation | Perme- | ability | perme- | Fault | body | block |
| Name | density | multiples | viscosity | thickness | ability | ratio | ability | density | multiples | area |
| 1 | 25.55 | 19.04 | 52.25 | 26.46 | 19.14 | 26.68 | 27.18 | 26.68 | 26.68 | 23.26 |
| 2 | 25.94 | 26.68 | 40.37 | 26.70 | 24.56 | 23.88 | 26.98 | 26.25 | 26.49 | 27.21 |
| 3 | 26.68 | 30.51 | 35.45 | 26.74 | 25.84 | 22.87 | 26.44 | 25.63 | 26.35 | 27.79 |
| 4 | 26.98 | 32.89 | 30.02 | 26.77 | 25.96 | 22.45 | 23.67 | 25.24 | 25.33 | 28.83 |
| 5 | 27.35 | 34.68 | 26.23 | 26.80 | 25.97 | 21.86 | 20.12 | 23.66 | 24.17 | 29.02 |
| Variance | 0.44 | 30.82 | 82.19 | 0.01 | 6.92 | 2.88 | 7.25 | 1.08 | 0.89 | 4.37 |
| Primary | 9 | 2 | 1 | 10 | 4 | 6 | 3 | 7 | 8 | 5 |
| and | | | | | | | | | | |
| secondary | | | | | | | | | | |
| factors | | | | | | | | | | |

As shown in Table 1, the primary and secondary factors of each of the influencing factors are: underground crude oil viscosity>production multiples>variation coefficient of permeability>permeability>fault block area>inter-layer permeability ratio>fault density>water body multiples>well spacing density>effective formation thickness. The influencing factors with variances greater than 1 are selected as master parameters of the water flooding recovery of the fault block reservoirs, including: underground crude oil viscosity, production multiples, variation coefficient of permeability, permeability, fault block area, inter-layer permeability ratio, and fault density.

The power function relationship, logarithmic function relationship and polynomial function relationship in step (3) are shown in formula (II), formula (III) and formula (IV), respectively:

R=aX^{b} (II)

R=a ln(X)+b (III)

R=a₀+a₁X+a₂X²+a₃X³+ . . . +aₙXⁿ+ . . . (IV)

In formula (II), formula (III) and formula (IV), R represents the recovery, %; X represents the master parameters; and a, b, aₙ represents undetermined coefficient of the functional relationship with a subscript n=0, 1, 2, 3 . . . .

In this embodiment, a correlation between flooding recovery of the fault block reservoirs and each of the master parameters is determined using non-linear regression method, where there is a power function relationship of the water flooding recovery with the permeability and inter-layer permeability ratio; there is a logarithmic function relationship of the water flooding recovery with the fault block area, production multiples and underground crude oil viscosity; there is a quadratic polynomial function relationship between the water flooding recovery and the variation coefficient of permeability; and there is a linear relationship between the water flooding recovery and the fault density.

A specific implementation process of step (4) includes:

Firstly, the upper and lower limits of values of parameters required for orthogonal experiment analysis were determined based on distribution intervals of the reservoir static physical parameters and fault block characteristic parameters determined in step (1) obtained from field tests.

Secondly, the upper and lower limits of values of the required production dynamic parameters were determined according to distribution intervals of the production dynamic parameters used in developed reservoirs of the same type. Several levels (5) were taken for each of the parameters in the orthogonal experiment analysis, and values of each of the levels were uniformly sampled between the upper and lower limits of the values of each of the parameters.

Finally, the orthogonal experimental design table was determined and the multi-factor orthogonal experimental schemes were compiled according to the determined number of the master parameters and several values (5) of the levels of each of the parameters.

In this embodiment, the number of levels of each of the master parameters is determined to be five in combination with relevant research data and the value range of the actual parameters of reservoir fields, the values thereof being shown in Table 2.

TABLE 2

| | | | | | | Inter- | Variation |
|---|---|---|---|---|---|---|---|
| | Fault | | Underground | Fault | | layer | coefficient |
| | block | Production | crude oil | density, | Perme- | perme- | of |
| | area, | multiples, | viscosity, | bar/ | ability, | ability | perme- |
| Name | km² | PV | mPa · s | km² | 10⁻³ μm² | ratio | ability |
| 1 | 0.0625 | 0.5 | 2 | 0 | 60 | 1.5 | 0.2 |
| 2 | 0.1875 | 2 | 10 | 1.11 | 500 | 5 | 0.5 |
| 3 | 0.375 | 4 | 20 | 4.44 | 1000 | 8 | 0.8 |
| 4 | 0.625 | 6 | 50 | 6.67 | 1500 | 10 | 1.2 |
| 5 | 0.9375 | 8 | 100 | 13.33 | 2000 | 15 | 1.5 |

On this basis, an orthogonal experimental design table with 7 influencing factors and 5 levels is selected. The obtained multi-factor orthogonal experimental scheme is shown in Table 3, which is the orthogonal experimental scheme for the master parameters of water flooding recovery of fault block reservoirs and the results of the whole process optimization thereof.

TABLE 3

| | | | | | | Inter- | Variation | |
|---|---|---|---|---|---|---|---|---|
| | Fault | | Underground | Fault | | layer | coefficient | |
| | block | | crude oil | density, | Perme- | perme- | of | |
| serial | area, | Production | viscosity, | bar/ | ability, | ability | perme- | Recovery, |
| number | km² | multiples | mPa · s | km² | 10⁻³ μm² | ratio | ability | % |
| 1 | 0.0625 | 0.5 | 2 | 0 | 60 | 1.5 | 0.2 | 42.73 |
| 2 | 0.0625 | 2 | 10 | 1.11 | 500 | 5 | 0.5 | 39.85 |
| 3 | 0.0625 | 4 | 20 | 4.44 | 1000 | 8 | 0.8 | 39.13 |
| 4 | 0.0625 | 6 | 50 | 6.67 | 1500 | 10 | 1.2 | 34.11 |
| 5 | 0.0625 | 8 | 100 | 13.33 | 2000 | 15 | 1.5 | 27.08 |
| 6 | 0.1875 | 0.5 | 10 | 4.44 | 1500 | 15 | 0.2 | 29.45 |
| 7 | 0.1875 | 2 | 20 | 6.67 | 2000 | 1.5 | 0.5 | 38.99 |
| 8 | 0.1875 | 4 | 50 | 13.33 | 60 | 5 | 0.8 | 34.89 |
| 9 | 0.1875 | 6 | 100 | 0 | 500 | 8 | 1.2 | 29.51 |
| 10 | 0.1875 | 8 | 2 | 1.11 | 1000 | 10 | 1.5 | 54.32 |
| 11 | 0.375 | 0.5 | 20 | 13.33 | 500 | 10 | 1.2 | 23.67 |
| 12 | 0.375 | 2 | 50 | 0 | 1000 | 15 | 1.5 | 22.41 |
| 13 | 0.375 | 4 | 100 | 1.11 | 1500 | 1.5 | 0.2 | 34.56 |
| 14 | 0.375 | 6 | 2 | 4.44 | 2000 | 5 | 0.5 | 58.28 |
| 15 | 0.375 | 8 | 10 | 6.67 | 60 | 8 | 0.8 | 48.6 |
| 16 | 0.625 | 0.5 | 50 | 1.11 | 2000 | 8 | 1.5 | 18.12 |
| 17 | 0.625 | 2 | 100 | 4.44 | 60 | 10 | 0.2 | 26.43 |
| 18 | 0.625 | 4 | 2 | 6.67 | 500 | 15 | 0.5 | 54.36 |
| 19 | 0.625 | 6 | 10 | 13.33 | 1000 | 1.5 | 0.8 | 51.28 |
| 20 | 0.625 | 8 | 20 | 0 | 1500 | 5 | 1.2 | 45.02 |
| 21 | 0.9375 | 0.5 | 100 | 6.67 | 1000 | 5 | 1.2 | 18.65 |
| 22 | 0.9375 | 2 | 2 | 13.33 | 1500 | 8 | 1.5 | 44.92 |
| 23 | 0.9375 | 4 | 10 | 0 | 2000 | 10 | 0.2 | 49.22 |
| 24 | 0.9375 | 6 | 20 | 1.11 | 60 | 15 | 0.5 | 42.74 |
| 25 | 0.9375 | 8 | 50 | 4.44 | 500 | 1.5 | 0.8 | 42.63 |
| 26 | 0.0625 | 0.5 | 2 | 6.67 | 2000 | 10 | 0.8 | 38.49 |
| 27 | 0.0625 | 2 | 10 | 13.33 | 60 | 15 | 1.2 | 33.75 |
| 28 | 0.0625 | 4 | 20 | 0 | 500 | 1.5 | 1.5 | 34.93 |
| 29 | 0.0625 | 6 | 50 | 1.11 | 1000 | 5 | 0.2 | 37.08 |
| 30 | 0.0625 | 8 | 100 | 4.44 | 1500 | 8 | 0.5 | 33.81 |
| 31 | 0.1875 | 0.5 | 10 | 0 | 1000 | 8 | 0.5 | 29.66 |
| 32 | 0.1875 | 2 | 20 | 1.11 | 1500 | 10 | 0.8 | 34.24 |
| 33 | 0.1875 | 4 | 50 | 4.44 | 2000 | 15 | 1.2 | 31.87 |
| 34 | 0.1875 | 6 | 100 | 6.67 | 60 | 1.5 | 1.5 | 26.3 |
| 35 | 0.1875 | 8 | 2 | 13.33 | 500 | 5 | 0.2 | 57.54 |
| 36 | 0.375 | 0.5 | 20 | 4.44 | 60 | 5 | 1.5 | 18.93 |
| 37 | 0.375 | 2 | 50 | 6.67 | 500 | 8 | 0.2 | 31.03 |
| 38 | 0.375 | 4 | 100 | 13.33 | 1000 | 10 | 0.5 | 30.7 |
| 39 | 0.375 | 6 | 2 | 0 | 1500 | 15 | 0.8 | 55.57 |
| 40 | 0.375 | 8 | 10 | 1.11 | 2000 | 1.5 | 1.2 | 51.27 |
| 41 | 0.625 | 0.5 | 50 | 13.33 | 1500 | 1.5 | 0.5 | 27.38 |
| 42 | 0.625 | 2 | 100 | 0 | 2000 | 5 | 0.8 | 26.63 |
| 43 | 0.625 | 4 | 2 | 1.11 | 60 | 8 | 1.2 | 53.33 |
| 44 | 0.625 | 6 | 10 | 4.44 | 500 | 10 | 1.5 | 42.34 |
| 45 | 0.625 | 8 | 20 | 6.67 | 1000 | 15 | 0.2 | 44.72 |
| 46 | 0.9375 | 0.5 | 100 | 1.11 | 500 | 15 | 0.8 | 19.4 |
| 47 | 0.9375 | 2 | 2 | 4.44 | 1000 | 1.5 | 1.2 | 51.48 |
| 48 | 0.9375 | 4 | 10 | 6.67 | 1500 | 5 | 1.5 | 40.3 |
| 49 | 0.9375 | 6 | 20 | 13.33 | 2000 | 8 | 0.2 | 45.08 |
| 50 | 0.9375 | 8 | 50 | 0 | 60 | 10 | 0.5 | 39.39 |

A specific implementation process of step (5) includes:

Multi-layer reservoirs were divided into two sets of layer series of development longitudinally at the moment of water flooding into production according to the orthogonal experiment schemes for each of the fault block reservoirs; specifically, different combinations of the multi-layer reservoirs were calculated by using numerical simulators of water flooding reservoirs, where the combination of the multi-layer reservoirs corresponding to the scheme with the maximum water flooding recovery was a preferred implementation of the separate-layer injection and production.

Producing wells were converted into water injection wells every other when the comprehensive water cut of the reservoirs reached 90%, that is, the original line of producing wells was converted into the producing wells and water injection wells arranged at intervals.

Injection rates of each of the water injection wells and liquid producing rates of each of the producing wells were calculated as adjustable variables by using the numerical simulators of water flooding reservoirs when the comprehensive water cut of the reservoirs reached 95%, where the combination of the injection rates of each of the water injection wells and the liquid producing rates of each of the producing wells corresponding to the scheme with the maximum water flooding recovery was a preferred injection and production scheme. The numerical simulation results of water flooding recovery of fault block reservoirs based on the whole process optimization are shown in Table 3.

The correlation model between the water flooding recovery of the fault block reservoirs and all the master parameters in step (6) is shown in formula (V):

R=a₁ ln(A)+a₂ log(PV)+a₃ ln(μₒ)+a₄(d_{f})+a₅k^{b}+a₆Vₘ^{c}+a₇Vᵣ²+a₈Vᵣ+a₉ (V)

In formula (V), R represents the recovery, %; A represents the fault block area, km²; PV represents the production multiples; μₒ represents the underground crude oil viscosity, mPa·s; d_{f} represents the fault density, bar/km²; k represents the permeability, 10⁻³ μm²; Vₘ represents the inter-layer permeability ratio; and Vᵣ represents the variation coefficient of permeability.

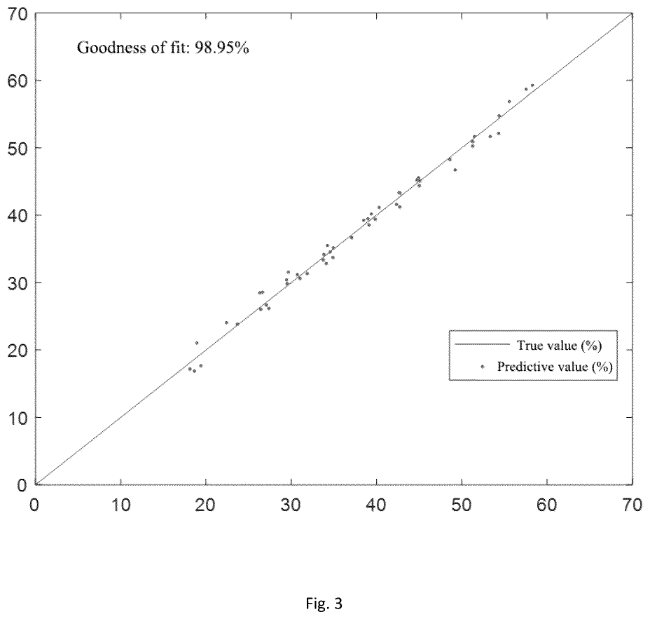

The verification results of the prediction model, with goodness of fit up to 98.95%, are shown in FIG. 3, indicating a high accuracy of the prediction model.

### Embodiment 3

A system for predicting water flooding recovery of fault block reservoirs considering a whole process optimization includes:
an influencing factor determining module, configured to determine influencing factors in water flooding recovery of fault block reservoirs;
a master parameter screening module, configured to screen master parameters of the water flooding recovery of the fault block reservoirs;
a single-factor correlation determining module, configured to determine a single-factor correlation between the water flooding recovery of the fault block reservoirs and the master parameters;
a multi-factor orthogonal experimental scheme designing module, configured to design multi-factor orthogonal experimental schemes based on the master parameters;
a whole-process water flooding optimizing module, configured to perform a whole-process water flooding optimization for each of the experimental schemes;
a prediction model establishing module, configured to establish a prediction model for the water flooding recovery of the fault block reservoirs; and
a water flooding recovery calculating module, configured to calculate the water flooding recovery of the fault block reservoirs according to the established prediction model of the water flooding recovery of the fault block reservoirs.

1-8. (canceled)

9. A method for predicting water flooding recovery of fault block reservoirs considering a whole process optimization, comprising a computer readable medium operable on a computer with memory for the method for predicting the water flooding recovery of the fault block reservoirs, and comprising program instructions for executing the following steps:
(1) determining influencing factors in water flooding recovery of fault block reservoirs
collecting geological information of fault block reservoirs in a target block, determining reservoir static physical parameters and production dynamic parameters in combination with field production data, and determining fault block characteristic parameters affecting the water flooding recovery of the fault block reservoirs based on fault block reservoir characteristics and actual development of the reservoirs;
(2) screening master parameters of the water flooding recovery of the fault block reservoirs
changing values of each of the influencing factors using single-factor analysis method, calculating the water flooding recovery of the fault block reservoirs by using numerical simulators of water flooding, analyzing significance of the influencing factors with a variance D as an evaluating criterion for primary and secondary influencing factors, wherein the greater the variance D is, the higher the significance of the influencing factors is, and selecting the influencing factors with variances greater than 1 as master parameters of the water flooding recovery of the fault block reservoirs;
(3) determining a single-factor correlation between the water flooding recovery of the fault block reservoirs and the master parameters
determining a correlation between the water flooding recovery of the fault block reservoirs and each of the master parameters using non-linear regression method, wherein the correlation comprises power function relationship, logarithmic function relationship, and polynomial function relationship;
(4) designing multi-factor orthogonal experimental schemes based on the master parameters
determining the number of levels and values of each of the master parameters in combination with allowable range of parameters in fault block reservoir field, and selecting an orthogonal experimental design table,
a specific implementation process of step (4) comprising:
firstly, determining the upper and lower limits of values of parameters required for orthogonal experiment analysis based on distribution intervals of the reservoir static physical parameters and fault block characteristic parameters determined in step (1) obtained from field tests;
secondly, determining the upper and lower limits of values of the required production dynamic parameters according to distribution intervals of the production dynamic parameter used in developed reservoirs of the same type, taking several levels for each of the parameters in the orthogonal experiment analysis, and uniformly sampling values of each of the levels between the upper and lower limits of the values of each of the parameters; and
finally, determining the orthogonal experimental design table and compiling the multi-factor orthogonal experimental schemes according to the determined number of the master parameters and several values of the levels of each of the parameters;
(5) performing a whole-process water flooding optimization for each of the orthogonal experimental schemes
with the maximum water flooding recovery as a target, optimizing separate-layer injection and production at the moment of production, optimizing well-type conversion when comprehensive water cut of the reservoirs reaches 90%, and optimizing injection and production adjustment when the comprehensive water cut of the reservoirs reaches 95%,
a specific implementation process of step (5) comprising:
dividing multi-layer reservoirs into two sets of layer series of development longitudinally when water flooding is put into production according to the orthogonal experimental schemes for each of the fault block reservoirs, and specifically, calculating different combinations of the multi-layer reservoirs by using numerical simulators of water flooding reservoirs, wherein the combination of the multi-layer reservoirs corresponding to the scheme with the maximum water flooding recovery is a preferred implementation of the separate-layer injection and production;
conversing producing wells into water injection wells every other well when the comprehensive water cut of the reservoirs reaches 90%, that is, conversing the original line of producing wells into the producing wells and the water injection wells arranged alternately; and
calculating injection rates of each of the water injection wells and liquid producing rates of each of the producing wells as adjustable variables by using the numerical simulators of water flooding reservoirs when the comprehensive water cut of the reservoirs reaches 95%, wherein the combination of the injection rates of each of the water injection wells and the liquid producing rates of each of the producing wells corresponding to the scheme with the maximum water flooding recovery is a preferred injection and production scheme;
(6) establishing a prediction model for the water flooding recovery of the fault block reservoirs
determining a formula of a correlation model of the water flooding recovery of the fault block reservoirs and all the master parameters according to the single-factor correlation between the water flooding recovery and the master parameters determined in step (3), determining unknown parameters of the formula of the correlation model of the water flooding recovery of the fault block reservoirs and all the master parameters using least square fitting method based on results of the whole process optimization of orthogonal experiments, and further obtaining a prediction model for the water flooding recovery of the fault block reservoirs, the correlation model of the water flooding recovery of the fault block reservoirs and all the master parameters being shown in formula (V):
R=a₁ ln(A)+a₂ log(PV)+a₃ ln(μₒ)+a₄(d_{f})+a₅k^{b}+a₆Vₘ^{c}+a₇Vᵣ²+a₈Vᵣ+a₉ (V)
where R represents the recovery, %; A represents the fault block area, km²; PV represents the production multiples; μₒ represents the underground crude oil viscosity, mPa·s; d_{f} represents the fault block density, block/km²; k represents the permeability, 10⁻³ μm²; Vₘ represents the inter-layer permeability ratio; Vᵣ represents the variation coefficient of permeability; and aₙ represents undetermined coefficient of the functional relationship with a subscript n=0, 1, 2, 3 . . . ;
(7) calculating the water flooding recovery of the fault block reservoirs
calculating the water flooding recovery of the fault block reservoirs according to the prediction model for the water flooding recovery of the fault block reservoirs established in step (6); and
(8) exploiting crude oils by water flooding development of the fault block reservoirs based on results of the method for predicting water flooding recovery of the fault block reservoirs.

10. The method for predicting water flooding recovery of fault block reservoirs considering a whole process optimization according to claim 9, wherein in step (1), the selected reservoir static physical parameters comprise underground crude oil viscosity μₒ, effective formation thickness h, permeability k, inter-layer permeability ratio Vₘ, and variation coefficient of permeability Vᵣ; the selected production dynamic parameters comprise the well spacing density w_{d} and produced volume multiples PV; and the selected fault block reservoir characteristic parameters comprise the fault block area A, fault block density d_{f}, and water body multiple N.

11. The method for predicting water flooding recovery of fault block reservoirs considering a whole process optimization according to claim 9, wherein the variance D in step (2) is calculated by formula (I):
$$D = \frac{{\sum }_{i = 1}^{n} {( {X}_{i} - X )}^{2}}{n} \qquad ( I )$$
where D represents the variance; n represents the number of samples; Xᵢ represents the water flooding recovery corresponding to an i^{th} value of a certain influencing factor, %; and X₁ represents an average value of n water flooding recovery, %.

12. The method for predicting water flooding recovery of fault block reservoirs considering a whole process optimization according to claim 9, wherein the power function relationship, logarithmic function relationship, and polynomial function relationship in step (3) are shown in formula (II), formula (III), and formula (IV), respectively:
R=aX^{b} (II)
R=a ln(X)+b (III)
R=a₀+a₁X+a₂X²+a₃X³+ . . . +aₙXⁿ+ . . . (IV)
where R represents the recovery, %; X represents the master parameters; a, b, and aₙ represent undetermined coefficients of the functional relationships with a subscript n=0, 1, 2, 3 . . . .

13. A system for predicting water flooding recovery of fault block reservoirs considering a whole process optimization, comprising:
a fault block reservoir water flooding recovery influencing factor determining circuit, configured to: determine influencing factors in water flooding recovery of fault block reservoirs, and specifically configured to: collect geological information of fault block reservoirs in a target block, determine reservoir static physical parameters and production dynamic parameters in combination with field production data, and determine fault block characteristic parameters affecting water flooding recovery of the fault block reservoirs based on fault block reservoir characteristics and actual development of the reservoirs;
a fault block reservoir water flooding recovery master parameter screening circuit, configured to: screen master parameters of the water flooding recovery of the fault block reservoir, and specifically configured to: change values of each of the influencing factors using single-factor analysis method, calculate the water flooding recovery of the fault block reservoirs by using numerical simulators of water flooding, analyze significance of the influencing factors with a variance D as an evaluating criterion for primary and secondary influencing factors, wherein the greater the variance D is, the higher the significance of the influencing factors is, and select the influencing factors with variances greater than 1 as master parameters of the water flooding recovery of the fault block reservoirs;
a fault block reservoir water flooding recovery and master parameter single-factor correlation determining circuit, configured to: determine a single-factor correlation between the water flooding recovery of the fault block reservoirs and the master parameters, and specifically configured to: determine a correlation between the water flooding recovery of the fault block reservoirs and each of the master parameters using non-linear regression method, wherein the correlation comprises power function relationship, logarithmic function relationship, and polynomial function relationship;
a multi-factor orthogonal experimental scheme designing circuit, configured to: design multi-factor orthogonal experimental schemes based on the master parameters, specifically configured to: determine the number of levels and values of each of the master parameters in combination with allowable range of parameters in fault block reservoir field, and select an orthogonal experimental design table, and further specifically configured to:
firstly, determine the upper and lower limits of values of parameters required for orthogonal experiment analysis based on distribution intervals of the reservoir static physical parameters and fault block characteristic parameters determined in step (1) obtained from field tests;
secondly, determine the upper and lower limits of values of the required production dynamic parameters according to distribution intervals of the production dynamic parameter used in developed reservoirs of the same type, take several levels for each of the parameters in the orthogonal experiment analysis, and uniformly sample values of each of the levels between the upper and lower limits of the values of each of the parameters; and
finally, determine the orthogonal experimental design table and compile the multi-factor orthogonal experimental schemes according to the determined number of the master parameters and several values of the levels of each of the parameters;
an experimental scheme whole-process water flooding optimizing circuit, configured to: perform a whole-process water flooding optimization for each of the experimental schemes, specifically configured to: with the maximum water flooding recovery as a target, optimize separate-layer injection and production at the moment of production, optimize well-type conversion when comprehensive water cut of the reservoirs reaches 90%, and optimize injection and production adjustment when the comprehensive water cut of the reservoirs reaches 95%, and further specifically configured to:
divide multi-layer reservoirs into two sets of layer series of development longitudinally when water flooding is put into production according to the orthogonal experimental schemes for each of the fault block reservoirs, and specifically, calculate different combinations of the multi-layer reservoirs by using numerical simulators of water flooding reservoirs, wherein the combination of the multi-layer reservoirs corresponding to the scheme with the maximum water flooding recovery is a preferred implementation of the separate-layer injection and production;
converse producing wells into water injection wells every other well when the comprehensive water cut of the reservoirs reaches 90%, that is, converse the original line of producing wells into the producing wells and the water injection wells arranged alternately; and
calculate injection rates of each of the water injection wells and liquid producing rates of each of the producing wells as adjustable variables by using the numerical simulators of water flooding reservoirs when the comprehensive water cut of the reservoirs reaches 95%, wherein the combination of the injection rates of each of the water injection wells and the liquid producing rates of each of the producing wells corresponding to the scheme with the maximum water flooding recovery is a preferred injection and production scheme;
a fault block reservoir water flooding recovery prediction model establishing circuit, configured to: establish a prediction model for the water flooding recovery of the fault block reservoirs, and specifically configured to: determine a formula of a correlation model of the water flooding recovery of the fault block reservoirs and all the master parameters according to the determined single-factor correlation between the water flooding recovery and the master parameters, determine unknown parameters of the formula of the correlation model of the water flooding recovery of the fault block reservoirs and all the master parameters using least square fitting method based on results of the whole process optimization of orthogonal experiments, and further obtain a prediction model for the water flooding recovery of the fault block reservoirs,
the correlation model of the water flooding recovery of the fault block reservoirs and all the master parameters being shown in formula (V):
R=a₁ ln(A)+a₂ log(PV)+a₃ ln(μₒ)+a₄(d_{f})+a₅k^{b}+a₆Vₘ^{c}+a₇Vᵣ²+a₈Vᵣ+a₉ (V)
where R represents the recovery, %; A represents the fault block area, km²; PV represents the production multiples; μₒ represents the underground crude oil viscosity, mPa·s; d_{f} represents the fault block density, block/km²; k represents the permeability, 10⁻³ μm²; Vₘ represents the inter-layer permeability ratio; Vᵣ represents the variation coefficient of permeability; and aₙ represents undetermined coefficient of the functional relationship with a subscript n=0, 1, 2, 3 . . . ; and
a fault block reservoir water flooding recovery calculating circuit, configured to: calculate the water flooding recovery of the fault block reservoirs according to the established prediction model for the water flooding recovery of the fault block reservoirs, and specifically configured to: calculate the water flooding recovery of the fault block reservoirs according to the established prediction model for the water flooding recovery of the fault block reservoirs; and
exploiting crude oils by water flooding development of the fault block reservoirs with the system for predicting the water flooding recovery of the fault block reservoirs.
